(19) United States
(12) Patent Application Publication
(10) Pub. No.: US 2023/0291262 A1
(43) Pub. Date: Sep. 14, 2023

(54) SLOT SEAL FOR AN ELECTRIC MACHINE

(71) Applicant: Siemens Aktiengesellschaft, 80333 München (DE)

(72) Inventor: Jakob Schneck, Berlin (DE)

(73) Assignee: Siemens Aktiengesellschaft, 80333 München (DE)

(21) Appl. No.: 18/029,322

(22) PCT Filed: Sep. 28, 2021
(86) PCT No.: PCT/EP2021/076574

§ 371 Date: Mar. 29, 2023

(30) Foreign Application Priority Data
Sep. 30, 2020 (EP) 20199131.2

(51) Int. Cl. H02K 3/24; H02K 9/20; H02K 9/22

(52) U.S. Cl. CPC H02K 3/24; H02K 9/20; H02K 9/225

(57) ABSTRACT

An electric machine includes an active part having a slot, and a slot seal for sealing the slot. The slot seal includes a duct for guiding a fluid and an aperture configured to open the duct to an air gap of the electric machine and forming a nozzle designed to enable a phase change of the fluid.

The invention relates to a slot seal of an electric machine, and also to an electric machine.

The invention further relates to a method for cooling an electric machine and/or a method for simulating the operation of the electric machine. Furthermore, the invention relates to a computer program for carrying out one of the methods, in particular when running in a control unit.

An electric machine is, for example, a motor or a generator. Electric machines can be synchronous machines or asynchronous machines. The electric machine has electrical conductors in an active part. The active part is, for example, a stator and/or a rotor of the electric machine. The electrical conductors can be positioned in slots, the slots being sealable by means of a slot seal.

Losses occur during operation of the electric machine. Losses are converted into heat in such electric rotating machines, for example, motors and generators, in particular in current-carrying windings, dynamo sheet metal bodies and solid iron parts. The machine components are heated. Cooling can be carried out in order to counteract the heating. The purpose of machine cooling is, in particular, the dissipation of the occurring waste heat flows to the environment in order not to exceed component temperature limits. In addition, the cooling or the operating temperatures occurring influence machine efficiency, machine utilization, production costs and/or, if appropriate, in particular in the case of permanently excited machines, material costs. There are open and closed cooling circuits. The cooling fluid can, for example, be gaseous (for example, air) or liquid (for example, water). Moreover, in particular by selecting the cooling method when the cooling circuit is closed, the size of the recooling plant, the volumetric and gravimetric power density and the costs of the entire machine, in particular the recooling plant, are scaled. The progressive torque or power density increase of electric machines, in particular of electrical heavy machinery with a rated output in the megawatt range (for example, 1 to 90 MW), is primarily limited by cooling measures as the volumes of the loss sources increase cubically, but their heat-dissipating surfaces only increase quadratically.

It is an object of the invention to improve the cooling of an electric machine.

The object is achieved in a slot seal as claimed in claim 1, in a method as claimed in claim 7 or in a computer program product as claimed in claim 12.

A slot seal is used to seal a slot of an active part of an electric machine. The slot seal has a duct for guiding a fluid. Thus, an electric machine has slots, the slots each having an air seal, the slot seal having a duct for guiding a fluid. The fluid is, for example, gaseous (for example, air) or liquid (for example, water). Thus, various concepts for the electric machine can be realized with the inclusion of evaporation or without evaporation. It is possible, for example, to use gases such as helium or hydrogen as fluid. This can be done, in particular, at pressures above the ambient temperature. Thus, in particular in comparison with air, more favorable heat capacities and heat transfer coefficients can be used with simultaneously lower ventilation losses. In addition to water, oils such as, for example silicon oils or esters, polyfluorinated alkyl compounds, etc., can also be used as fluid.

The fluid is guided in an open cooling circuit and/or in a closed cooling circuit. Thus, the fluid can be guided, for example, via a heat exchanger which emits the heat absorbed by the fluid, for example, to the air. In particular, a fan must be provided for this purpose, a fanless design also being possible. The invention makes it possible, in particular, to improve a wide variety of cooling concepts. Thus, in one embodiment of a cooling concept, components with inherent heat development which are in direct contact with air (cooling air) can also be cooled in a closed circuit (in particular, therefore, a closed air circuit) and the heat absorbed by the air is subsequently released into the environment in an air-water or air-air heat exchanger without significantly increasing the complexity of the system.

In one embodiment of the slot seal, it has a plurality of ducts. As a result, for example, a return of the fluid can be carried out This can also be used to compensate for the temperature distribution via the slot by the fluid.

In one embodiment of the slot seal, the slot seal has an aperture, the aperture opening the duct to(ward) the air gap of the electric machine. As a result, fluid can escape for increased cooling. If the fluid (gas) expands as it escapes, additional cooling can be achieved.

In one embodiment of the slot seal, the aperture has a nozzle or the aperture is configured as a nozzle. A direction of the escaping air can be predetermined by the nozzle, or by nozzles. The use of a nozzle is also suitable for expanding a gas.

In one embodiment of the slot seal, the slot seal has a surface which is three-dimensional in order to achieve a surface enlargement of the surface which, in the installed state of the slot seal, is directed toward the air gap in the electric machine. This improves heat dissipation.

An electric machine has a slot in an active part of the electric machine. In particular, an electric machine has a plurality of slots, electrical windings being placed in the slots of the active part of the electric machine. The slot or the slots are sealed by means of a slot seal. The embodiment of the slot seal is described here in various variations. The slot seal or the slot seals have one or more ducts. The electric machine may, for example, only have slot seals with ducts or else a mixture of slot seals with and without a duct. This depends, for example, on the required cooling capacity.

In one embodiment of the electric machine, a slot seal has a duct or a plurality of ducts. Furthermore, in one embodiment of the electric machine, it has only slot seals with one duct each. In a further embodiment of the electric machine, it has slot seals each with at least two ducts. In a further embodiment of the electric machine, these slot seals have a different number of ducts. Thus, slot seals with a different number of ducts can alternate or connect over the circumference of the electric machine. In this way, different cooling requirements of the electric machine can be flexibly addressed.

The slot seal can have a wedge shape. For this reason, the slot seal can also be referred to as a slot seal wedge. The slot seal seals in slots of an active part of the electric machine. The active part of the electric machine is a stator and/or a rotor of the electric machine.

In one embodiment of the electric machine, the duct in the slot seal and/or the slot seal is in the same radial position as a scatter bar. This produces a compact design, for example.

In one embodiment of the electric machine, the slot seal has a first surface which is facing the slot, or the slot base, and a second surface which is facing away from the slot, or the slot base, the second surface being able to emit more thermal energy than the first surface, the second surface being directed toward the air gap of the electric machine. Thus, more thermal energy is guided to the air gap. A cooling fluid such as air or water can be guided through the air gap. The second surface has, for example, a greater surface roughness than the first surface. Thus, the second surface can be made larger than the first surface. The second surface can also have, for example, a wave shape, a serrated shape or a comb shape, with these shapes resulting in a surface enlargement compared to a two-dimensional flat surface.

In one embodiment of the electric machine, the slot seal wedges which are used to fix the winding in the slot are designed with internal ducts (≥ 1) so that a cooling medium (fluid) can flow through them. The cooled wedges thus represent a heat sink which is located in the immediate vicinity of the heat source (current-carrying conductor) and thus cools the coils and the teeth. In addition, the in particular gaseous cooling medium flowing in the air gap is likewise cooled on the outside of the wedge. This surface can be designed such that the heat transfer surface is maximized (for example, by high surface roughness). As the cross section of the cooled slot seal wedges will increase, this is advantageously formed or embodied in the region of the scatter bar. For cooling concepts which use a phase change in order to increase the cooling capacity, at least one wedge can be designed in such a way that it has openings at defined intervals in the direction of the air gap through which the cooling medium can escape. Optionally, the openings may have a nozzle geometry. As a result, the cooling medium can be sprayed directly onto the rotor in order to likewise cool the latter. In order not to influence the electromagnetic properties of the machine, it is advantageous to pay attention to the choice of material of the wedges.

According to a method for cooling an electric machine, wherein the electric machine has slots, wherein the slots are sealed with slot seals, wherein at least one slot seal wedge has a duct, a fluid for cooling the electric machine is guided through the duct. Thus, the cooling medium (fluid) is close to the region of the electric machine, which leads to heating of the electric machine. In this way, efficient cooling of the electric machine is possible.

According to one embodiment of the method, a slot seal according to one of the described embodiments can be used.

According to one embodiment of the method, the fluid is guided into the air gap of the electric machine and in particular sprayed or guided onto the rotor of the electric machine. Thus, the cooling effect can be further enhanced. The spraying or guiding of the fluid onto the rotor is made possible, for example, by holes, slots, open pores and/or nozzles in the duct or slot seal.

In one embodiment of the method, a phase change of the fluid is used for cooling the electric machine. Thus, for example, a liquid fluid can be evaporated in order to improve the cooling effect. In a further embodiment of the method, a gaseous fluid can be expanded. The fluid thus first has a first pressure and after the expansion a second pressure, the first pressure being higher than the second pressure. A cooling effect can also be achieved by the expansion of the gaseous fluid.

In one embodiment of the method, this method is simulated. Thus, for example, the cooling of an electric machine can be simulated. Thus, for example, the operation of the electric machine can also be simulated and, in particular, the operating states can also be simulated as a function of the required power.

In one embodiment of the method, the method thus relates to simulated operation. For example, the operation of the electric machine in a wind turbine or a machine facility is simulated. As a result, for example, the design of the wind turbine or the machine facility can be improved. The machine facility is, for example, a pump facility, a compressor facility (compressor), an electric locomotive or the like. The simulation also makes it possible to form a digital twin. Thus, for example, monitoring can take place parallel to the operation of the electric machine in order, for example, to calculate a peak power that can still be called up for a certain time and/or to detect an impending error.

A computer program product can be provided which has computer-executable program means and, when executed on a computer facility with processor means and data storage means, is suitable for carrying out a method according to one of the described types. Thus, an underlying problem can be solved by a computer program product which is designed to simulate an operating behavior of the electric machine. For this purpose, the computer program product can comprise data of the electric machine. The computer program product can also have a data interface via which operating parameters such as, for example, a rotational speed, a motor current and/or a temperature can be predefined or entered. Likewise, the computer program product can also have a data interface for outputting simulation results. The electric machine, the operating behavior of which can be simulated by means of the computer program product, is designed in particular according to at least one of the outlined embodiments. For this purpose, the computer program product can be embodied, for example, as a so-called digital twin.

A computer program product or the computer program product therefore has computer-executable program means and is suitable for execution on a computer facility with processor means and data storage means in order to simulate at least one of the described methods of at least one of the described electric machines.

The invention is described in more detail hereinafter with reference to diagrammatic exemplary embodiments. Elements of the same type are provided with the same reference characters.

it is shown in:

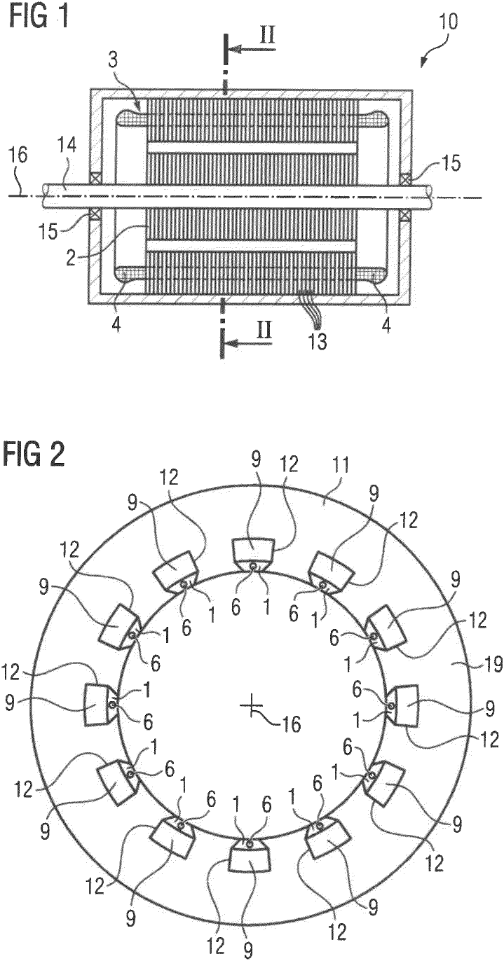

FIG. 1 a longitudinal section through an electric machine,

FIG. 2 a section through the electric machine of FIG. 1 according to a line II-II in FIG. 1,

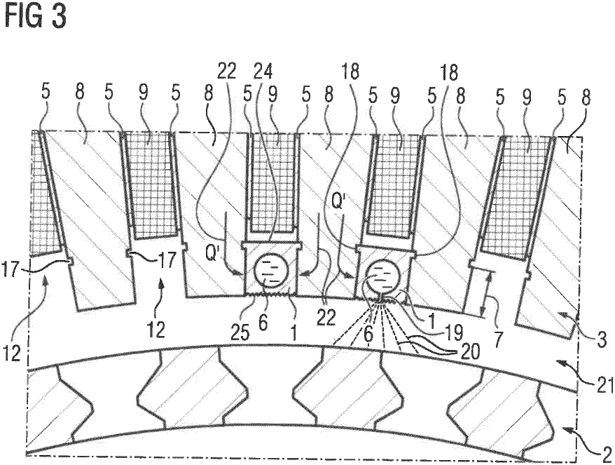

FIG. 3 a further section through an electric machine,

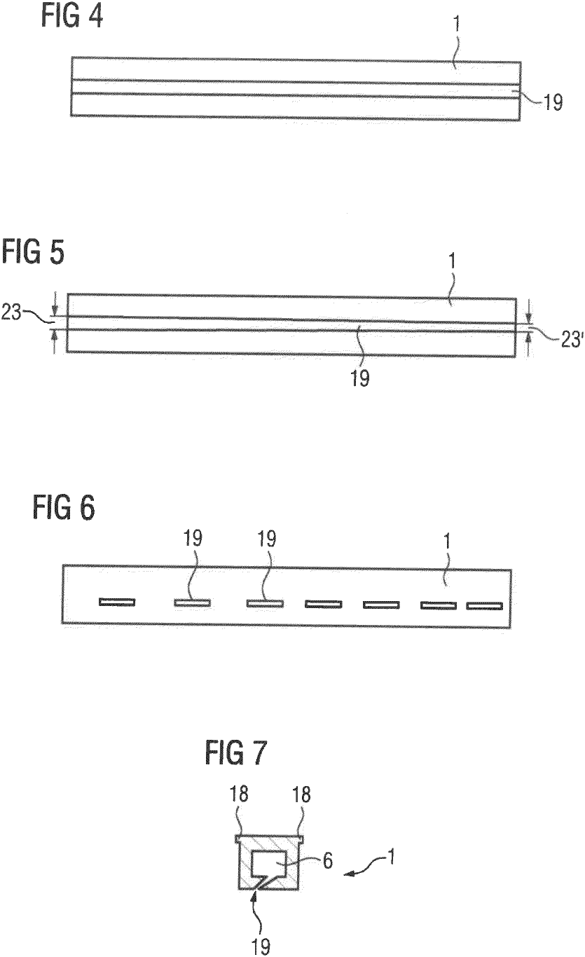

FIG. 4 a top view of a slot seal,

FIG. 5 a further top view of a slot seal,

FIG. 6 a further top view of a slot seal, and

FIG. 7 a cross section of a slot seal.

FIG. 1 shows a longitudinal section through an electric machine 10. According to FIG. 1, the rotatory electric machine 10 has a rotor 2 and a stator 3 with a laminated stator core and winding heads 4. The rotor 2 is arranged on a rotor shaft 14. The rotor shaft 14 is mounted in bearings 15, so that the rotor shaft 14 can be rotated about an axis of rotation 16.

Insofar as the terms “axial”, “radial” and “tangential” are used, “axial” means a direction parallel to the axis of rotation 16. “Radial” is a direction orthogonal to the axial direction directly toward or away from the axis of rotation 6. “Tangential” is a direction which is both orthogonal to the axial direction and orthogonal to the radial direction. Tangential is therefore a direction which is directed in a circle around the axis of rotation 6 at a constant axial position and at a constant radial distance from the axis of rotation 16.

The laminated stator core has stator laminations 13. The laminated stator core has slots 12. These slots 12 are stator slots and run parallel to the axis of rotation 16 of the electric machine 10. They are arranged in a circle around the axis of rotation 16 (see FIG. 2).

FIG. 2 shows a section through the electric machine of FIG. 1 according to a line II-II in FIG. 1 with a laminated stator core 11. The stator slots 12 are initially open toward the axis of rotation 16 - that is to say, radially inward. The windings 9 of a stator winding system are arranged in the stator slots 12. The main sections of the windings 9 are arranged in the stator slots 12. Winding heads 4 of the windings 9 project, as is generally customary, according to FIG. 1 at the two axial ends of the laminated stator core beyond the laminated stator core 3. The slots 12 are sealed by slot seals 1, the slot seals 1 each having a duct 6.

FIG. 3 shows a further section through an electric machine with a stator 2 and a rotor 3. Teeth 8 are shown through which the slots 12 are formed. The teeth 8 have a scatter bar 7. The windings 9 are insulated from the teeth 8 by insulation 5 in the slot 12. The teeth 8 have grooves 17. Holding webs 18 of the slot seals 1, 1′ can engage in these grooves 17. Two slot seals 1 are shown by way of example in FIG. 3. In addition to holding webs 18, the slot seals 1 also each have a duct 6. The duct 6 of the slot seal 1′ has an aperture 19. Fluid 20 can escape from this aperture 19 into the air gap 21. As a result of the fluid 20 in the duct 6, thermal energy Q′, which is symbolized by an arrow 22 as a heat flow, can be carried out from the teeth or the stator, i.e. dissipated. The slot seal 1 has a first surface 24 and a second surface 25. The first surface 24 is smoother in comparison with the second surface 25. The second surface 25 is thus larger than the first surface 24 and can thus emit more thermal energy with regard to the surface structure.

The illustration according to FIG. 4 shows a top view of a slot seal 1 which has an aperture 19 which extends over the length of the slot seal 19 and is centered.

The illustration according to FIG. 5 shows a further top view of a slot seal 1 which has an aperture 19, the width 23, 23′ changes. As a result, the outlet volume of the fluid can be adjusted over the length.

The illustration according to FIG. 6 shows a further top view of a slot seal 1, with a plurality of apertures 19 which are at a different distance from one another. The outlet volume of the fluid can also be adjusted over the length as a result of this.

The illustration according to FIG. 7 shows a cross section of a slot seal 1. The slot seal 1 has holding webs 18 and a duct 6. The duct 6 has an aperture 19 which is designed as a nozzle. The aperture 19 tapers toward the outlet and thus forms the nozzle. The outlet direction of the fluid can be better determined by the nozzle, for example.

What is claimed is:

1-12. (canceled)

13. An electric machine, comprising:
an active part having a slot; and
a slot seal for sealing the slot, said slot seal including a duct for guiding a fluid and an aperture configured to open the duct to an air gap of the electric machine and forming a nozzle designed to enable a phase change of the fluid.

14. The electric machine of claim 13, wherein the duct is in a same radial position as a scatter bar.

15. The electric machine of claim 13, wherein the slot seal has a first surface which faces the slot and a second surface which faces away from the slot and is configured to emit more thermal energy than the first surface, said second surface directed toward the air gap of the electric machine.

16. A method for cooling an electric machine, said method comprising:
sealing slots of the electric machine with slot seals;
guiding a fluid through a duct of at least one of the slot seals; and
configuring the at least one of the slot seals with an aperture which opens the duct to an air gap of the electric machine and forms a nozzle designed to enable a phase change of the fluid for cooling the electric machine.

17. The method of claim 16, wherein the slots are formed in an active part of the electric machine.

18. The method of claim 16, wherein the duct is in a same radial position as a scatter bar.

19. The method of claim 16, wherein the at least one of the slot seals has a first surface which faces a corresponding one of the slots and a second surface which faces away from the slot and is configured to emit more thermal energy than the first surface, said second surface directed toward the air gap of the electric machine.

20. The method of claim 16, wherein the fluid is guided into the air gap of the electric machine.

21. The method of claim 17, wherein the active part is a rotor, and further comprising spraying the fluid onto the rotor.

22. The method of claim 16, wherein the method is simulated.

23. A computer program product, comprising:
a computer-executable program; and
a non-transitory storage device having stored thereon the computer-executable program that, when loaded into a processor of a computer facility and executed by the processor, causes the processor to
perform the steps of sealing slots of the electric machine with slot seals, guiding a fluid through a duct of at least one of the slot seals, and configuring the at least one of the slot seals with an aperture which opens the duct to an air gap of the electric machine and forms a nozzle designed to enable a phase change of the fluid for cooling the electric machine, and/or
simulate an electric machine comprising an active part having a slot, and a slot seal for sealing the slot, said slot seal including a duct for guiding a fluid and an aperture configured to open the duct to an air gap of the electric machine and forming a nozzle designed to enable a phase change of the fluid.
